(19) United States
(12) Patent Application Publication
(10) Pub. No.: US 2026/0368148 A1
(43) Pub. Date: Nov. 19, 2026

(54) INDEX BASED ON BLOOM-FILTER RESULT CACHING FOR IMPROVED RELATIONAL EQUIJOIN PERFORMANCE

(71) Applicant: Oracle International Corporation, Redwood Shores, CA (US)

(72) Inventors: Kaan Kara, Zurich (CH); Panagiotis Sioulas, Zurich (CH); Cagri Balkesen, Zurich (CH); Harikrishnan Prabakaran, Kumbakonam (IN); Malika Agarwal, Bangalore (IN); Nipun Agarwal, Saratoga, CA (US); Nitin Kunal, Zurich (CH)

(21) Appl. No.: 19/212,035

(22) Filed: May 19, 2025

(51) Int. Cl. G06F 16/22; G06F 16/2453; G06F 16/2455

(52) U.S. Cl. CPC G06F 16/2228; G06F 16/24539; G06F 16/24552; G06F 16/2456

(57) ABSTRACT

Herein is relational query acceleration by a compact representation of equijoin results that is designed for hardware caching. For a query that includes an equijoin operation on a first and a second database object, a Bloom filter (BF) is generated based on reading data from the first database object. The BF is applied to items in the second database object to identify identifiers to a strict subset of items, and these identifiers are stored into a BF index in volatile memory. The equijoin operation is performed for the first query based on the first database object and the strict subset of items. During executing a second query that includes the same equijoin operation, the identifiers in the BF index are used to identify the strict subset of items. The equijoin operation is performed for the second query based on the first database object and the strict subset of items.

### FIELD OF THE DISCLOSURE

This disclosure regards relational query acceleration by a compact representation of equijoin results that is designed for hardware caching.

### BACKGROUND

In structured query language (SQL), an equijoin is a common type of relational join that retrieves rows from two or more tables where the values of specified columns are equal. This facilitates combining related information from different sources into a single, unified result to return as an answer to a query or for further processing by the query. A naively implemented join may be slow because its complexity is greater than linear to a count of rows processed in two tables being joined. A hash join between two tables may entail a build phase to process one table followed by a probe phase to process the other table, and both phases have linear complexity and use hashing. For a hash join, linear complexity may entail a table scan of persistent data on disk, which is slow due to input/output (I/O) latency.

A same hash join may be specified in multiple somewhat similar queries, and a same query can be repeatedly submitted. Thus, a hash join may be repeatedly executed to redundantly generate identical results. A query cache (a.k.a. query result cache or server result cache) is a state of the art way to store the results of executed queries, including a query that was executed with a hash join. This allows the database to quickly retrieve and return previously computed results if the exact same query is executed again, rather than re-processing the query. When a query is executed, the database system checks the query cache. If a matching query and its corresponding result set are found, the cached result is returned without re-executing the query. Query caches are most effective in read-mostly environments where data changes infrequently. Data modifications (e.g. inserts, updates, deletes) typically invalidate related cached queries, which can lead to cache invalidation latency.

A hardware cache in a central processing unit (CPU) may accelerate data processing. However even if database tables are in volatile memory, a table scan might thrash (i.e. entirely invalidate) the hardware cache and might thrash a software cache of database blocks. Thrashing a cache of database blocks entails slow disk I/O to load cache misses and, during eviction, to writeback dirty database blocks.

In a distributed database setting, a join index can present a significant data-gathering burden, primarily due to the need to access and potentially move data across different nodes (database instances) in the distributed system. The following factors contribute to this overhead. Join columns that are not co-located may cause deceleration. If tables being joined reside on different database nodes, or if join columns are not efficiently partitioned or co-located, the database needs to retrieve the relevant data from remote nodes to perform the join. This data retrieval across the network introduces significant latency and increases network traffic, which can become a bottleneck, especially for large tables or frequently executed join queries. A join index is expensive to maintain due to distributed index updates. When data in the involved database tables is modified, the join index also needs to be updated. In a distributed environment, this means coordinating index updates across all nodes where the involved data resides.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example relational database management system (RDBMS) that accelerates queries by generation and retention of a Bloom filter (BF) index in volatile memory;

FIG. 2 is a flow diagram that depicts an example query acceleration process performed by an RDBMS;

FIG. 3 is a flow diagram that depicts example query acceleration activities performed by an RDBMS;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method are provided for relational query acceleration by a compact representation of equijoin results that is designed for hardware caching. In this approach, a (e.g. partitioned) hash join is unconventionally accelerated using a Bloom filter in an innovative way to prefilter data before the partitioning stages. This approach creates an innovative Bloom Lookup Cache Index (BLC-Index) from Bloom filter results. This index stores physical row identifiers of tuples that satisfy a join predicate. The index is created from a previous run of the same join, while applying the Bloom filter on a base relation. For a distributed hash join and because the index is created before the partitioning of data, the index is collocated with the corresponding data in the same distributed processing node. This overcomes the data-gathering burden of conventional join indexes in distributed settings as discussed in the above Background.

A Bloom filter is an array of bits used in a special way for filtration. A Bloom filter herein may exceed a megabyte in size and its bits may be randomly accessed, which may challenge a hardware cache. The approach herein entails a novel distributed join processing technique that mitigates the high cost of Bloom filter lookups and addresses the cost of building a distributed Bloom filter. This approach stores Bloom filter lookup results from previously performed equivalent equijoins. This stored internal result is the BLC-Index, which can be reused in subsequent runs of the same join to significantly speedup regeneration of join results. A Bloom filter is fast but inaccurate due to false positives, where a false positive is a tuple that should be excluded from an equijoin, but only after additional processing to detect that the tuple is not a true positive.

This approach includes the following technologic innovations. In volatile memory, physical row identifiers (rowids) are retained that are associated with physical storage locations of tuples that are (i.e. true or false) positives from the Bloom filter in the index. A query cache does stores neither a rowid nor a logical block address (LBA). For innovative acceleration, the rowids can be reused in subsequent runs of the same join to directly access the tuples of interest. Because the insertion of rowids into the BLC-Index happens while scanning a database table, this approach directly has access to the physical storage location identifiers of the data.

In a distributed setting, partitioning stages shuffle data across the processing nodes. With the BLC-Index, this approach creates the index before the data gets shuffled. This provides acceleration because both the index and its associated data remains local to the processing node, which conserves network bandwidth and, for acceleration, minimizes network latency. From an earlier query, reusing an existing BLC-Index in a distributed partitioned join accelerates the join processing in a subsequent query, such as when the same query is rerun or with templated queries.

Using a BLC-Index not only for the same query, but also for other queries that can be compiled to contain the same join subtree, which a query cache cannot do, provides additional innovative acceleration. Informing the query optimizer and the query compiler about the existence and the contents of the BLC-Index provides acceleration, and the optimizer uses this information to obtain accurate join cardinality estimations, which leads to more accurate join costing. Consequently, the optimizer proposes join orderings that execute faster as discussed later herein. Having accurate join cardinality estimations, the physical optimizer can correctly pick the right distributed join algorithm (e.g. broadcast vs. partitioned hash-join) and decide on the correct number of partitioning rounds as discussed later herein. The BLC-Index is managed as a soft-state data structure that can be discarded with very minimal overhead when volatile memory capacity is low.

This approach primarily provides the following technologic advantage. Generating the BLC-Index during a first run of a join does not incur any performance cost because that cost can be eliminated by prefetching and hardware caching as discussed later herein.

### 1.0 Example Query Acceleration Computer Hosts Relational Database Management System (RDBMS)

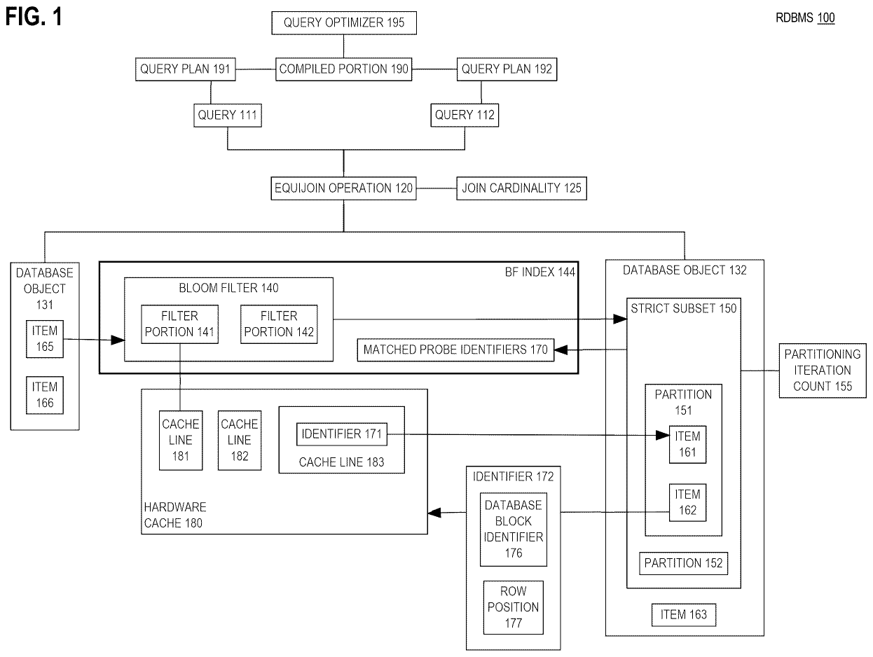

FIG. 1 is a block diagram that depicts example relational database management system (RDBMS) 100 that accelerates queries 111-112 by generation and retention of acceleration data structures 140, 144, and 170-172 in volatile memory. Collectively referred to as Bloom filter (BF) index 144, acceleration data structures 140 and 170 together are a compact representation of results of equijoin operation 120, and this compact representation is designed for hardware caching. BF index 144 is also referred to as a Bloom Lookup Cache Index (BLC-Index). RDBMS 100 is hosted by one or more computers such as a virtual machine, a blade or other rack server, or a mainframe.

RDMS 100 contains a database (not shown) that contains database objects 131-132. In an embodiment, either or both of database objects 131-132 is a tabular data structure such as a database table or other row set. In an embodiment, either or both of database objects 131-132 is one or more database columns. In any case, each of database objects 131-132 is a data aggregation structure that contains multiple items such as table rows or column values. For example, database object 132 contains items 161-163. Likewise, database object 131 contains items 165-166.

Each of queries 111-112 references both database objects 131-132. Each of queries 111-112 may be a database statement in a language such as a structured query language (SQL), data query language (DQL), or data manipulation language (DML). Queries 111-112 are somewhat similar because each specifies equijoin operation 120 to join database objects 131-132. For each of database objects 131-132, equijoin operation 120 specifies one or more columns as join columns that are used to filter items as discussed later herein.

In the following example queries 111-112, table1 and table2 are respective database objects 131-132. The following is an example query 111 that contains a SQL WHERE clause.

SELECT*FROM table1, table2 WHERE table1.column1=table2.column2;

The following is an example query 112 that does not contain a SQL WHERE clause.

SELECT*FROM table1 INNER JOIN table2 ON table1.column1=table2.column2;

In both above example queries 111-112, example equijoin operation 120 is table1.column1=table2.column2. Equijoin operation 120 may reference one or multiple columns in each of table1 and table2.

### 1.1 Example Biphasic Hash Join

In an embodiment, equijoin operation 120 is implemented as a hash join with Bloom filter 140 that indicates which items are in database object 131. Bloom filter 140 is populated during a build phase of the hash join, and database object 131 may be referred to herein as a build object. Subsequently, Bloom filter 140 is read during a probe phase of the hash join, and database object 132 may be referred to herein as a probe object.

Herein, items 165-166 in build database object 131 may be referred to as build items. Herein, items 161-162 in probe database object 131 may be referred to as probe items. Equijoin operation 120 is an equijoin of build items to probe items. The result of equijoin operation 120 is a result set of distinct matched pairs, and each matched pair has two matched items that are one matched build item and one matched probe item.

Acceleration data structures 140, 144, and 170-172 are a compact and accelerated representation of results of equijoin operation 120. For acceleration as discussed later herein, BF index 144 may reside entirely in volatile memory, and BF index 144 is decomposed into fine grained acceleration data structures 141-142 and 171-172 that each can fit in a respective one of cache lines 181-184 in hardware cache 180.

Example equijoin operation 120 is table1.column1=table2.column2, which references two columns and two tables, although more columns could be referenced. All columns referenced in equijoin operation 120 are referred to herein as join columns. Each of database objects 131-132 may be or contain one or more join columns and zero or more columns that are not join columns. For example, one or both of database objects 131-132 may consist solely of a single join column.

Herein, a join key is one or more join columns in either one of database objects 131-132, and a join key value is a tuple consisting of a value for each join column in that database object. In above example queries 111-112, table1.column1 is a join key, and table2.column2 is another join key. In above example queries 111-112, a join key value is a single scalar value.

Each of above example queries 111-112 specifies: a) filtration of exactly two join columns and b) projection of, for example, dozens of columns spanning hundreds of bytes from each of database objects 131-132. On average, projection from database object 131 entails an order of magnitude more projection columns than join columns in equijoin operation 120. In an embodiment for either of above example queries 111-112 that match values of one join column to another join column, Bloom filter 140 indicates which distinct keys are in the join column in database object 131.

Bloom filter 140 is generated during the build phase and retained in volatile memory to overcome data access latencies in the probe phase. Before the build phase, Bloom filter 140 contains an array of bits that all are initially zero. Bloom filter 140 operates as a logical set of distinct join key values from database object 131. For example, database object 131 may be a database table, and Bloom filter 140 may operate somewhat like a logical set of join key values from the database table.

However, Bloom filter 140 does not store values of a join key. Bloom filter 140 instead unreliably stores hash codes of join key values. For each join key value, multiple hash codes from multiple hash functions are generated and unreliably stored in Bloom filter 140. Each hash code in Bloom filter 140 is an integer bounded by a count of bits in the bit array. Inserting one hash code into Bloom filter 140 entails assigning one as a value to exactly one bit that is positionally identified by the hash code, regardless of what was the previous value of that bit.

For example, each join key value may have five hash codes, and inserting a join key value into Bloom filter 140 entails setting exactly five bits in the bit array as positionally identified by the five hash codes. If all five bits were not already set to one, then it is guaranteed that Bloom filter 140 did not previously contain that join key value.

Absence (a.k.a. miss) of a particular join key value in Bloom filter 140 is detected with perfect accuracy. Presence (a.k.a. hit) of a particular join key value in Bloom filter 140 is unreliably detected and prone to false positives. True and false positives from Bloom filter 140 can be disambiguated as discussed later herein. All negatives from Bloom filter 140 are true negatives. True negatives are accelerated herein by avoidance of data access. During the probe phase, database object 132 is not accessed to process a true negative that was detected by reading Bloom filter 140. As discussed later herein, item 163 is a true negative.

### 1.2 Bloom Filter (BF) Index in Volatile Memory

Acceleration data structures 140, 144, and 170-172 are a compact and accelerated representation of results of equijoin operation 120, and this compact representation is designed for hardware caching in the following two ways that are: a) retention in volatile memory of physical identifiers 176-177 and b) segmentation of Bloom filter 140.

Although Bloom filter 140 logically consists of a one-dimensional array of bits, Bloom filter 140 may be physically decomposed into multiple filter portions 141-142 that each is a portion of the bit array. The bit array has a larger predefined size (i.e. count of bits), and filter portions 141-142 have a same smaller predefined size that is the size of each of cache lines 181-183. For example as shown, cache line 181 contains filter portion 141, and filter portion 142 is not in hardware cache 180. In an embodiment, hardware cache 180 is any one of a level 1-3 cache in a central processing unit (CPU).

For acceleration of the probe phase, all of identifiers 171-172 and 176-177 are retained in volatile memory. Identifiers 171-172 each identifies a distinct item (e.g. tuple, table row, or column value) in database object 132. Identifiers 171-172 respectively identify items 161-162 in database object 132. Identifiers 171-172 identify only special items, which is each item that is both a probe item and a matched item as discussed earlier herein. That is, identifiers 171-172 identify only matched probe items. Identifiers of matched probe items are the only identifiers that the BF index retains, shown as matched probe identifiers 170.

As discussed earlier herein, the result of equijoin operation 120 is a result set of distinct matched pairs of two matched items that are one matched build item and one matched probe item. Bloom filter 140 is prone to false positives that cause falsely matched pairs of items that should not be included in the join result set. Thus, either or both of identifiers 171-172 of matched probe items 161-162 might be a false match. That is, BF index 144 might contain some identifiers that are false positives. Herein, a false positive entails a falsely matched probe item that has no corresponding build item. BF index 144 does not contain identifiers that are (i.e. true) negative from Bloom filter 140.

Herein, a positive that might be a true positive or a false positive is referred to as an ambiguous positive or an overinclusive positive. Herein, any set of ambiguous positives is referred to as an overinclusive set. Acceleration components 140, 144, 150-152, and 170-172 are overinclusive. Strict subset 150 is the set of ambiguously matched probe items, including items 161-162 but not item 163 that is a true negative.

Overinclusive matched probe identifiers 170 are determined in the probe phase. Matched probe identifiers 170 are the identifiers of ambiguously matched probe items in strict subset 150. Matched probe identifiers 170 includes identifiers 171-172. Even if identifier 171 is a false positive, identifier 171 is retained in matched probe identifiers 170 before identifier 171 is disambiguated. All of acceleration data structures 140, 144, and 170 are retained in volatile memory to unconventionally accelerate subsequent queries as discussed later herein.

### 1.3 Physical Persistence Locations

The following is a physical persistence embodiment that uses physical persistence identifiers to disambiguate an ambiguously matched probe identifier. Probe database object 132 consists of many probe items 161-163 that are too many to store in a single database block. Subsets of probe items are stored in each of multiple database blocks that each contains a portion of database object 132, and these database blocks may be referred to herein as probe database blocks.

Each database block in database object 132 may contain: a) only probe items that are true negatives that do not match any build item, b) only true positives, c) only false positives, or d) any mix of (a)-(c). The probe phase is accelerated because database blocks that contain only true negatives are not accessed during the probe phase, and identifiers of database blocks that contain only true negatives are not retained in matched probe identifiers 170. Each identifier in overinclusive matched probe identifiers 170 consists of an identifier of a persistent database block and a row position into that database block. For example, database block identifier 176 indicates which database block contains ambiguously matched probe item 162. Database block identifier 176 indicates a database block that contains at least one positive, even if that is a false positive.

Row position 177 indicates the location of item 162 within the database block indicated by database block identifier 176. If items 161-163 have a same fixed size, then the database block is treated as a one-dimensional array of items, and row position 177 is an integer that is a zero-based array offset into the array of items. If items 161-163 have variable sizes, then the database block is instead treated as a one-dimensional array of bytes or machine words, and row position 177 is an integer that is a byte or word offset of a first byte or word of item 162 within the array.

### 1.4 Distributed Partitions of Database Objects for Acceleration by Horizontal Scaling

Acceleration by horizontal scaling is initialized herein by dividing strict subset 150 into multiple horizontal partitions 151-152 that are distributed to multiple processors such as computers, virtual machines, or processor cores for concurrent processing of multiple partitions 151-152. A partitioned hash join herein entails assigning each ambiguously matched probe item to a respective one of multiple partitions 151-152. For example, partition 151 contains items 161-162, and this assignment is based on the join key values of items 161-162.

In an embodiment, iterative partitioning is as follows. Initially, there is only one partition, and it contains strict subset 150. In each iteration in a sequence of partitioning iterations, any partition that contains more than a predefined maximum count of items is split into two new partitions that replace the partition. When a partition is being split, which of the two new partitions is each item assigned to depends on the join key value of the item. Splitting a partition that is too big entails dividing the join key value range of the big partition into two equal contiguous subranges. A previous iteration may split one or more partitions and generate zero or more new partitions that are too big and that will be split in a next iteration. Partitioning iteration ceases when no partition is too big. When iteration ceases, some or many partitions may contain fewer than the maximum partition size.

RDMBS 100 contains multiple partition processors such as computers, virtual machines, or processor cores. In an embodiment, horizontal scaling is maximized by a one-to-one assignment of partitions to partition processors. In an embodiment, acceleration is provided by provisioning multiple partition processors before iterative partitioning starts or before iterative partitioning has generated all partitions. An actual count of partitions is undetermined until all partitions are generated and, due to varied actual sizes of partitions, a state of the art prediction of the actual count of partitions is inaccurate.

In an embodiment, wasteful overallocation of too many partition processors is prevented by accurately estimating partitioning iteration count 155 before iterative partitioning. Acceleration data structures 140, 144, and 170 are populated before iterative partitioning. Embodiments may accurately calculate quantitative estimates 125 and 155 by inspecting either of acceleration data structures 140 or 170.

As discussed earlier herein, the result of equijoin operation 120 is a result set of matched pairs of two matched items that are one matched build item and one matched probe item. Join cardinality 125 is an accurate estimate of a count of matched pairs that equijoin operation 120 will generate.

### 2.0 Example Query Acceleration Process

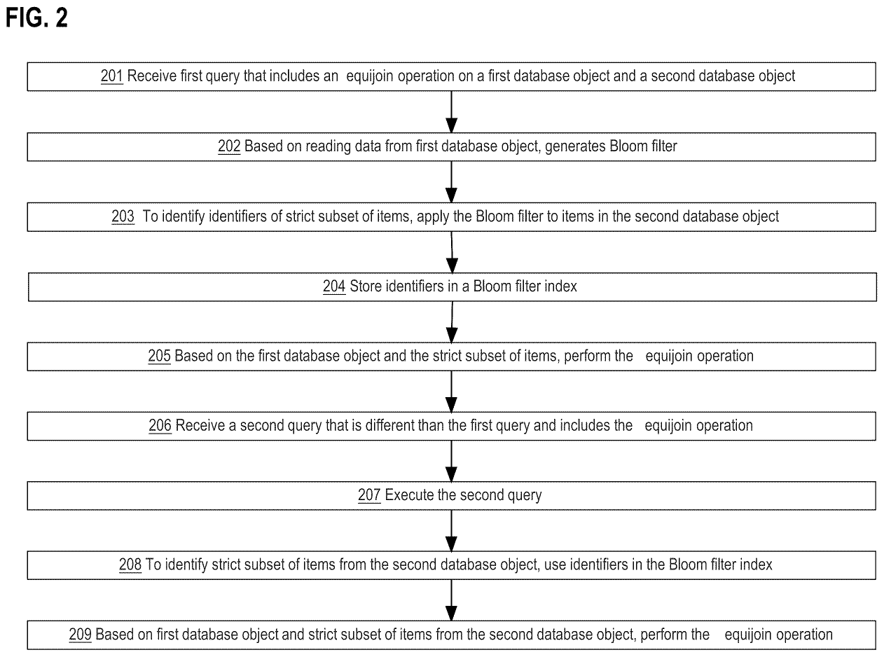

FIG. 2 is a flow diagram that depicts an example process performed by relational database management system (RDBMS) 100 that accelerates queries 111-112 by generation and retention of acceleration data structures 140, 144, and 170-172 in volatile memory. The process of FIG. 2 performs a hash join that is repeated for each of queries 111-112 and, in this example, query 111 executes before query 112 executes. In that case, a second hash join for query 112 is a repetition of a first hash join for query 111. As discussed earlier herein, the first hash join has a build phase followed by a probe phase that is accelerated by Bloom filter 140, but this is not how the second hash join works. Even though the second hash join does not use Bloom filter 140, the second hash join has greater acceleration in a different way by: a) avoidance of most or all of the build phase and b) in the probe phase, avoidance of a scan of database object 132 by reuse of matched probe identifiers 170.

Steps 201-205 process first query 111. Step 201 receives first query 111 that includes equijoin operation 120 on first database object 131 and second database object 132. For example through a network connection, step 201 may use open database connectivity (ODBC) to receive query 111 from a database client.

For query 111, the build phase entails step 202 during a scan of database object 131. For example, the build phase may perform a table scan or a column scan. Based on reading data from database object 131, step 202 generates Bloom filter 140 in volatile memory as part of Bloom filter (BF) index 144. For each item 165-166, step 202 may insert the item into Bloom filter 140, which may entail generating multiple hash codes and accordingly setting multiple bits in Bloom filter 140 as discussed earlier herein.

For query 111, the probe phase entails steps 203-205 during a scan of database object 132. To identify matched probe identifiers 170 of matched probe items 161-162 in strict subset 150, step 203 applies Bloom filter 140 to items 161-163 in database object 132 as discussed earlier herein. In BF index 144 in volatile memory, step 204 stores ambiguously matched probe identifiers 170.

Based on database object 131 and strict subset 150, step 205 performs equijoin operation 120 for query 111. As discussed earlier herein, acceleration data structures 140, 144, 150, and 170 are overinclusive due to false positives. Step 205 detects and excludes false matches as discussed later herein.

Steps 206-209 unconventionally accelerate second query 112 by reusing BF index 144. Step 206 receives second query 112 that, although different than first query 111, includes same equijoin operation 120. Step 207 executes query 112, which entails performing sub-steps 208-209. To identify strict subset 150 from second database object 132, step 208 uses matched probe identifiers 170 in BF index 144. For unconventional acceleration, step 208 does not access any of data structures 140, 132, and 161-163. Based on first database object 131 and matched probe identifiers 170 of strict subset 150, step 209 performs equijoin operation 120. Step 209 disambiguates true and false positives as discussed later herein.

Steps 207-209 may handle false positives but, for acceleration, steps 207-209 do not encounter true negatives because matched probe identifiers 170 does not contain an identifier of a true negative. For acceleration, performing equijoin operation 120 for query 112 does not access true negative item 163.

### 3.0 Example Query Acceleration Activities

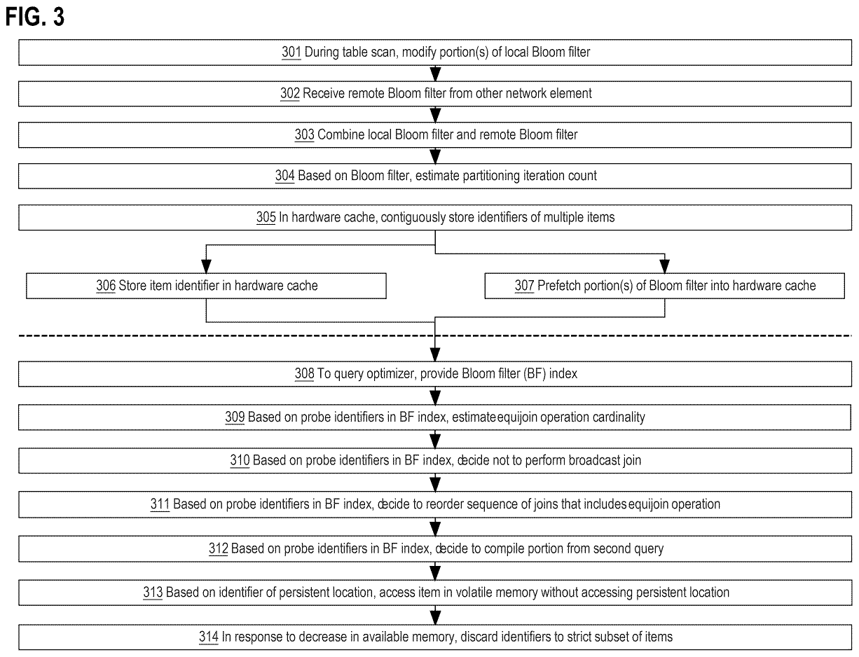

FIG. 3 is a flow diagram that depicts example activities performed by relational database management system (RDBMS) 100 that accelerates queries 111-112. The dashed horizontal line between steps 307-308 indicates that steps 301-307 process query 111, and steps 308-314 unconventionally accelerate query 112. The processes of FIGS. 2-3 may be combined into a single combined process in which some steps from both processes may be interleaved or combined.

For acceleration by horizontal scaling, this example implements join operation 120 as a distributed hash join that entails a local hash join on a separate database processor for each of partitions 151-152. Herein, multiple database processors may be multiple network elements separated by a communication network or, if not separated by a communication network, may be multiple processing cores in a central processing unit (CPU). In a partitioned embodiment, partitions 151-152 are not processed by a same database processor.

Herein are two kinds of hash functions, which are a filter hash function for Bloom filter 140 and a partition hash function for partitioning (i.e. generating partitions 151-152). From a join key of an item, a partition hash function generates a hash code that identifies a partition.

For acceleration, the partition hash function is not applied to probe items that are (i.e. true) negatives from Bloom filter 140, and partitions 151-152 do not contain true negatives.

Larger database object 132 may, for example, contain more items than smaller database object 131 contains. Although not shown in FIG. 1, database object 131 is partitioned and distributed to, for example, two computers during the build phase for query 111. Distribution of items from database object 131 to network elements is according to the join key of equijoin operation 120 such that all items in database object 131 having a same join key value are persisted on a same computer, and that computer may also contain other items in database object 131 having some other join key values.

### 3.1 Build Phase of First Query

As discussed earlier, performing join operation 120 entails a similar hash join for each of queries 111-112 and, for first query 111, the hash join entails a build phase followed by a probe phase. For query 111, the build phase entails steps 301-303. Step 301 scans database object 131 that is a table or column. From multiple hash functions during the scan, step 301 generates multiple hash codes for each item from database object 131 and, as discussed earlier herein, each hash code is inserted into Bloom filter 140 by setting a respective bit in the bit array that consists of filter portions 141-142. In that way, step 301 modifies filter portions 141-142 in Bloom filter 140.

During step 301 at each database processor (e.g. network element), Bloom filter 140 is a local Bloom filter that is entirely locally generated based on a local partition of database object 131. In step 302, each network element sends its respective local Bloom filter to the other network element(s). Also in step 302, each network element receives a remote Bloom filter from each other network element.

Into its local Bloom filter in step 303, each network element combines received remote Bloom filter(s). Step 303 may use bitwise union (i.e. bitwise or) to combine all remote Bloom filters into the local Bloom filter 140. In that way, all network elements generate their own identical copies of a same combined global Bloom filter 140.

### 3.2 Probe Phase of First Query

The probe phase for query 111 entails steps 304-307. Based on Bloom filter 140, step 304 estimates partitioning iteration count 155 as discussed earlier herein. Steps 305-307 occur during a scan of database object 132.

In hardware cache 180 or in dynamic random access memory (DRAM), step 305 contiguously stores some or all identifiers in matched probe identifiers 170. Step 306 is a sub-step of step 305 and, for acceleration by pipeline parallelism, steps 306-307 concurrently occur as shown. Step 306 stores identifier 171 in hardware cache line 183. For acceleration, step 307 prefetches next filter portion 142 into hardware cache line 182. Although filter portions 141-142 may sometimes be accessed sequentially (i.e. one after the other), herein random access to a filter portion occurs during random access to a bit in the bit array of Bloom filter 140 during the build phase or the probe phase as discussed earlier herein.

### 3.3 Unconventionally Accelerated Second Query

The dashed horizontal line between steps 307-308 indicates that execution of components 111 and 120 finishes before step 308. For second query 112, an embodiment may, for example, avoid Bloom filter 140 and the build phase. However, Bloom filter 140 may accelerate query 112 in the ways of step 304 above and steps 309-312 as follows.

Ordering of steps 308-312 depends on the embodiment. Step 308 provides Bloom filter (BF) index 144 to a query optimizer or query planner. In an embodiment, some or all of steps 309-312 are sub-steps of step 308, and the query optimizer performs those sub-steps.

Based on either of acceleration components 140 or 170, step 309 estimates join cardinality 125 as discussed earlier herein. Based on matched probe identifiers 170 in BF index 144, step 310 decides to perform, in this example, a partitioned hash join instead of a broadcast join, and partitioning components 151-152 and 155 are discussed earlier herein.

Although not shown in FIG. 1, often an online analytic processing (OLAP) query or a reporting query may specify a compound join of more than two relational tables. A compound equijoin may contain multiple equijoin operations, and one BF index 144 accelerates one equijoin operation 120. Based on matched probe identifiers 170 in BF index 144, step 311 decides to reorder a sequence of multiple join operations for acceleration. For example, join operation 120 may execute before the other join operations.

Based on matched probe identifiers 170 in BF index 144, step 312 decides to compile a portion from second query 112. That portion occurs in both queries 111-112, and that portion specifies at least join operation 120. For example, that portion may be: a) a whole or part of a SQL WHERE clause and/or b) join operation 120 and nothing more. For example, queries 111-112 may have respective parse trees that contain an identical subtree that includes join operation 120, and query plans 191-192 may both be partially based on that common subtree. Step 312 may use a backend (i.e. code generator) of a programing language compiler to compile the common portion of query plans 191-192 directly to native machine instructions, shown as compiled portion 190.

As discussed earlier herein, identifier 172 contains physical identifiers 176-177 that each identifies a persistent location. Database block identifier 176 identifies a database block as a persistent location, and that database block can be cached in volatile memory. Based on one or both of physical identifiers 176-177, step 313 accesses matched probe item 162 in a buffer pool in volatile memory without accessing the persistent location. For example, step 313 may disambiguate ambiguously matched probe item 162 to decide whether to exclude item 162 while executing equijoin operation 120. Disambiguation of true and false positives may instead be performed by accessing the persistent location if volatile memory does not contain that database block.

Herein, accessing a persistent location entails accessing a local partition (e.g. on a local disk) as discussed earlier herein. To save memory, matched probe identifiers 170 do not contain identifiers of network elements nor identifiers of partitions, because those identifiers are unnecessary for local processing.

Herein, disambiguation does not use a hash table, and absence of a hash table, including avoiding constructing a hash table, accelerates the build phase of the hash join and conserves memory. In response to a decrease in available memory below a threshold, step 314 discards acceleration data structures 140, 144, and 170. If equijoin operation 120 later needs re-execution after discarding BF index 144, techniques herein may be repeated to regenerate BF index 144. In those ways, RDBMS 100 can dynamically adjust a tradeoff between acceleration and available memory.

### 6.0 Database System Overview

A database management system (DBMS) manages one or more databases. A DBMS may comprise one or more database servers. A database comprises database data and a database dictionary that are stored on a persistent memory mechanism, such as a set of hard disks. Database data may be stored in one or more data containers. Each container contains records. The data within each record is organized into one or more fields. In relational DBMSs, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database command may be in the form of a database statement that conforms to a database language. A database language for expressing the database commands is the Structured Query Language (SQL). There are many different versions of SQL, some versions are standard and some proprietary, and there are a variety of extensions. Data definition language (“DDL”) commands are issued to a database server to create or configure database objects, such as tables, views, or complex data types. SQL/XML is a common extension of SQL used when manipulating XML data in an object-relational database.

A multi-node database management system is made up of interconnected nodes that share access to the same database or databases. Typically, the nodes are interconnected via a network and share access, in varying degrees, to shared storage, e.g. shared access to a set of disk drives and data blocks stored thereon. The varying degrees of shared access between the nodes may include shared nothing, shared everything, exclusive access to database partitions by node, or some combination thereof. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

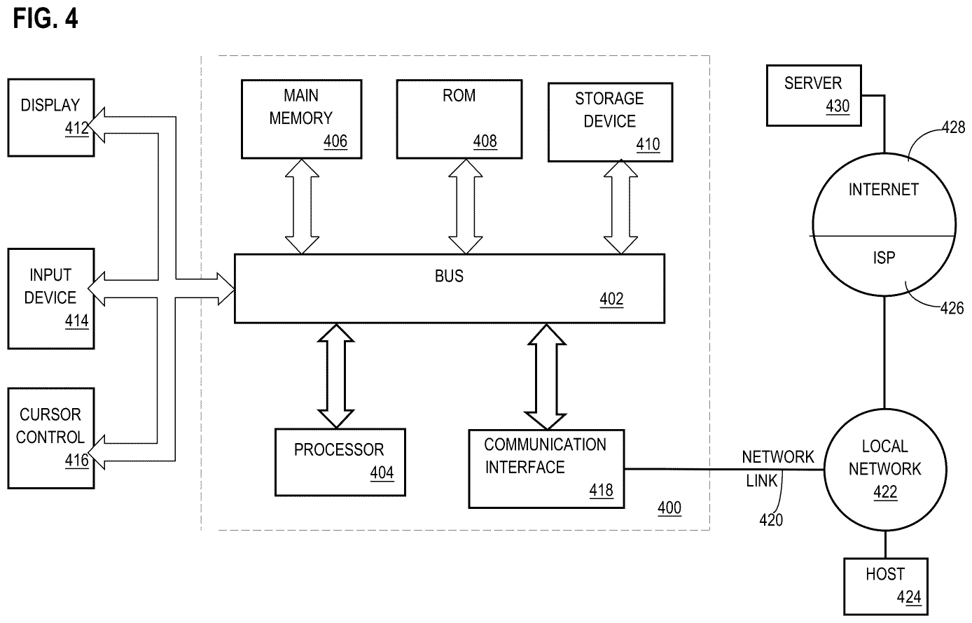

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412.

This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

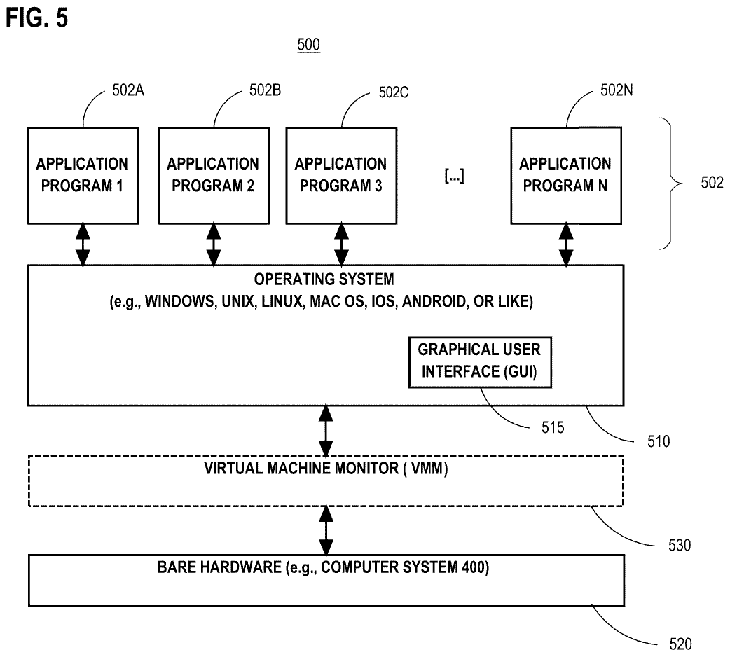

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 500 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (Saas), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
in response to receiving a first query that includes an equijoin operation on two database objects comprising a first database object and a second database object:
generating a Bloom filter based on reading data from the first database object,
applying the Bloom filter to a set of items in the second database object to identify a set of identifiers to a strict subset of the set of items,
storing the set of identifiers in a Bloom filter index, and
performing the equijoin operation based on the first database object and the strict subset of the set of items; and
in response to receiving a second query that is different than the first query and includes the equijoin operation:
during executing of the second query, using the set of identifiers in the Bloom filter index to identify the strict subset of items from the second database object, and
performing the equijoin operation based on the first database object and the strict subset of items;
wherein the method is performed by one or more computing devices.

2. The method of claim 1 wherein:
the set of items in the second database object comprises a particular item that is not in the strict subset of items;
said executing of the second query does not access the particular item.

3. The method of claim 1 further comprising based on the Bloom filter index, performing at least one estimation selected from a group consisting of:
a prediction of a count of partitioning iterations and
an estimation of a cardinality of the equijoin operation.

4. The method of claim 1 wherein:
said storing the set of identifiers comprises to a query optimizer, providing the Bloom filter index;
said performing the equijoin operation in response to receiving the second query comprises based on the set of identifiers in the Bloom filter index, making at least one decision from a group consisting of:
a decision not to perform a broadcast join,
a decision to reorder a sequence of joins that includes the equijoin operation, and
a decision to compile a portion from the second query, wherein the portion specifies the equijoin operation.

5. The method of claim 1 wherein:
a first portion of the Bloom filter is contained in a hardware cache;
a second portion of the Bloom filter is not contained in the hardware cache;
the strict subset of items from the second database object includes a first item that has a particular identifier and a second item;
said generating comprises during a table scan, modifying the second portion of the Bloom filter;
the method further comprises concurrently in response to receiving the first query:
prefetching the second portion of the Bloom filter into the hardware cache, and storing the particular identifier in the hardware cache.

6. The method of claim 5 further comprising in volatile memory or the hardware cache, contiguously storing the particular identifier and an identifier of the second item.

7. The method of claim 1 further comprising in response to a decrease in available memory, discarding the set of identifiers to the strict subset of items from the second database object.

8. The method of claim 1 wherein a particular identifier in the set of identifiers comprises at least one of an identifier of a database block for a particular item in the strict subset of the set of items or a position in the database block.

9. The method of claim 1 wherein:
the one or more computing devices comprises a first network element and a second network element;
said generating the Bloom filter comprises the first network element performing:
generating a local Bloom filter,
receiving a remote Bloom filter from the second network element, and
combining the local Bloom filter and the remote Bloom filter;
said applying the Bloom filter comprises the first network element applying the Bloom filter to items in a partition of the second database object.

10. The method of claim 1 wherein each identifier in the set of identifiers does not comprise an identifier of a network element nor an identifier of a partition.

11. The method of claim 1 wherein:
a particular identifier in the set of identifiers comprises a persistent location for a particular item in the strict subset of the set of items;
said performing the equijoin operation in response to receiving the second query comprises based on an identifier of the persistent location, accessing the particular item in volatile memory without accessing the persistent location.

12. One or more computer-readable non-transitory media storing instructions that, when executed by one or more computers, cause:
in response to receiving a first query that includes an equijoin operation on two database objects comprising a first database object and a second database object:
generating a Bloom filter based on reading data from the first database object,
applying the Bloom filter to a set of items in the second database object to identify a set of identifiers to a strict subset of the set of items,
storing the set of identifiers in a Bloom filter index, and
performing the equijoin operation based on the first database object and the strict subset of the set of items; and
in response to receiving a second query that is different than the first query and includes the equijoin operation:
during executing of the second query, using the set of identifiers in the Bloom filter index to identify the strict subset of items from the second database object, and
performing the equijoin operation based on the first database object and the strict subset of items.

13. The one or more computer-readable non-transitory media of claim 12 wherein:
the set of items in the second database object comprises a particular item that is not in the strict subset of items;
said executing of the second query does not access the particular item.

14. The one or more computer-readable non-transitory media of claim 12 wherein the instructions further cause based on the Bloom filter index, performing at least one estimation selected from a group consisting of:
a prediction of a count of partitioning iterations and
an estimation of a cardinality of the equijoin operation.

15. The one or more computer-readable non-transitory media of claim 12 wherein:
said storing the set of identifiers comprises to a query optimizer, providing the Bloom filter index;
said performing the equijoin operation in response to receiving the second query comprises based on the set of identifiers in the Bloom filter index, making at least one decision from a group consisting of:
a decision not to perform a broadcast join,
a decision to reorder a sequence of joins that includes the equijoin operation, and
a decision to compile a portion from the second query, wherein the portion specifies the equijoin operation.

16. The one or more computer-readable non-transitory media of claim 12 wherein:
a first portion of the Bloom filter is contained in a hardware cache;
a second portion of the Bloom filter is not contained in the hardware cache;
the strict subset of items from the second database object includes a first item that has a particular identifier and a second item;
said generating comprises during a table scan, modifying the second portion of the Bloom filter;
the instructions further cause concurrently in response to receiving the first query:
prefetching the second portion of the Bloom filter into the hardware cache, and storing the particular identifier in the hardware cache.

17. The one or more computer-readable non-transitory media of claim 12 wherein the instructions further cause in response to a decrease in available memory, discarding the set of identifiers to the strict subset of items from the second database object.

18. The one or more computer-readable non-transitory media of claim 12 wherein a particular identifier in the set of identifiers comprises at least one of an identifier of a database block for a particular item in the strict subset of the set of items or a position in the database block.

19. The one or more computer-readable non-transitory media of claim 12 wherein:
the one or more computing devices comprises a first network element and a second network element;
said generating the Bloom filter comprises the first network element performing:
generating a local Bloom filter,
receiving a remote Bloom filter from the second network element, and
combining the local Bloom filter and the remote Bloom filter;
said applying the Bloom filter comprises the first network element applying the Bloom filter to items in a partition of the second database object.

20. The one or more computer-readable non-transitory media of claim 12 wherein each identifier in the set of identifiers does not comprise an identifier of a network element nor an identifier of a partition.
